(19) United States
(12) Patent Application Publication
(10) Pub. No.: US 2020/0047595 A1
(43) Pub. Date: Feb. 13, 2020

(54) VARIABLE RATIO ADHESIVE APPLICATION

(71) Applicant: Magna Exteriors Inc., Concord (CA)

(72) Inventors: Keijo J. Huotari, Fenton, MI (US); Mike Karpinski, Blissfield, MI (US)

(73) Assignee: Magna Exteriors Inc., Concord, ON (CA)

(21) Appl. No.: 16/342,350

(22) PCT Filed: Oct. 19, 2017
(86) PCT No.: PCT/IB2017/001441

§ 371 Date: Apr. 16, 2019

Related U.S. Application Data
(60) Provisional application No. 62/410,125, filed on Oct. 19, 2016.

(51) Int. Cl. B60J 1/00; B62D 65/06; C09J 5/06; C09J 11/08; C09J 11/04; C09J 11/06

(52) U.S. Cl. CPC B60J 1/006; B62D 65/06; C09J 5/06; C09J 11/08; C09J 2475/00; C09J 11/06; C09J 2205/31; C09J 2400/143; C09J 2400/163; C09J 11/04

(57) ABSTRACT

A process for adhering a window to a frame comprising the steps of: providing a frame for a window having a peripheral surface for mating to an outer peripheral surface of a window; applying a bead of curable adhesive at least partially around the peripheral surface of the frame or on the outer peripheral surface of the window; and adding a boosting agent to the bead of curable adhesive at preselected areas of the peripheral surface of the frame or of the outer peripheral surface of the window for securely holding the window in place upon assembly of the window into the frame.

### CROSS-REFERENCE TO RELATED APPLICATIONS

This application claims the benefit of U.S. Provisional Application No. 62/410,125, filed Oct. 19, 2016. The disclosure of the above application is incorporated herein by reference.

### FIELD OF THE INVENTION

The present invention relates to an adhesive application for a window for a vehicle.

### BACKGROUND OF THE INVENTION

In manufacturing generally and in the area of vehicle window installation adhesives are typically used to connect the windows, such as windshields, rear windows and other non-movable windows to the vehicle body. Adhesives dispensing during the manufacturing process is typically accomplished using a one (1) component or two (2) component adhesive system. When a one (1) component, such a windshield adhesive is used, it is a slow curing adhesive requiring moisture to cure. Full cure can take up to 7 days. During this time period secondary attachments are then used such as locking pins, and dual lock (Velcro). These secondary attachments require either an additional piece, additional steps or additional material to be used. These secondary attachments also require additional tooling and manufacturing space to be accommodated. Some of the one (1) component adhesives can be accelerated by a booster being added but this is also expensive and creates less than ideal results. Where two (2) component adhesives are used, the process provides the advantage of faster curing time, however it is more expensive.

The present invention seeks to modify the one component adhesive system creating a hybrid system that selectively uses a booster component as a booster, which eliminates the need for secondary fastener, maintaining cost effective final solution. The present invention also seeks to provide a hybrid single component system where an adhesive booster is used selectively at strategic locations in order to eliminate the need for secondary attachment structures.

### SUMMARY OF THE INVENTION

A process for adhering a window to a frame includes several steps. A first step of the process includes providing a frame for a window having a peripheral surface for contacting an outer peripheral surface of a window. The peripheral surface and the outer peripheral surface have two or more mating corners. Next the process includes applying a bead of curable adhesive at least partially around the peripheral surface or on the outer peripheral surface of the window such that the bead of curable adhesive is positioned between the peripheral surface and the outer peripheral surface. The step of applying the bead of curable adhesive further includes applying to at least two or more pre-selectable areas, at the two or more mating corners, a boosting agent added to the curable adhesive for securely holding the window in place upon assembly of the window onto the frame.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan front view of a vehicle lift gate having a frame opening with a rear glass being adhesively bonded to the frame opening using the curable adhesive and boosting agent in accordance with the present invention.

FIG. 2 is a plan front view of a vehicle windshield having a frame opening with a front glass being adhesively bonded to the frame opening using the curable adhesive and boosting agent in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

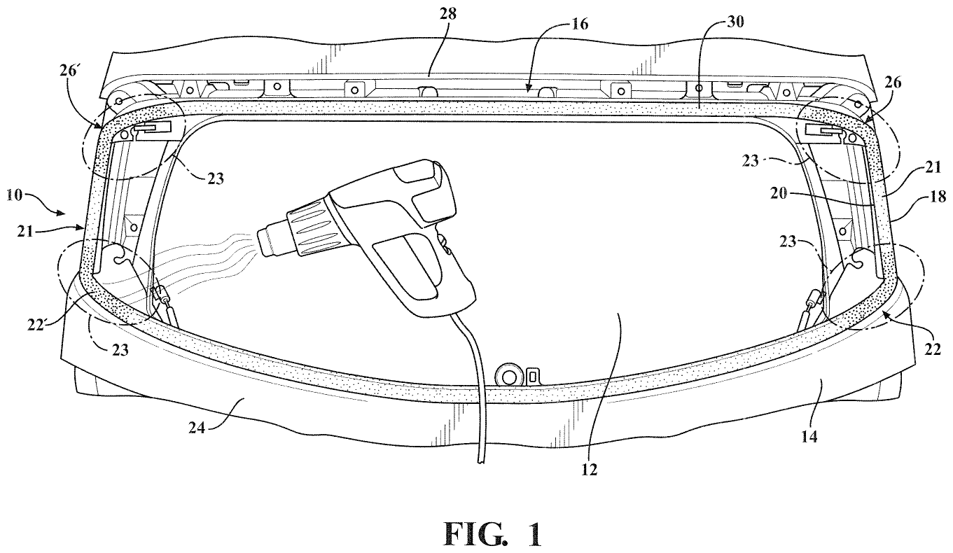

FIG. 1 shows a process for adhering a window glass to a vehicle body. In particular FIG. 1 shows a rear lift gate 10 having a rear glass 12 connected or placed on to a lift gate 14 across an opening defined by an inner peripheral surface 20 on a frame 16 of the lift gate 14. The frame 16 of the lift gate 14 also has with an outer peripheral surface 18. While a lift gate 14 is shown and described it is within the scope of this invention for the process to be implemented on other vehicle body panel such as doors, windshields, etc. The outer peripheral surface 18 is configured to contact with glass of the window 12. As shown in FIG. 1 the outer peripheral surface 18 and inner peripheral surface 20 have a have two or more mating corners generally indicated at 23 where there are two top corners 26, 26′ and two bottom corners 22, 22′. The bottom corners 22, 22′ are located adjacent a lower portion 24 of the lift gate 14, while the top corners 26, 26′ are located adjacent or near an upper frame 28 of the lift gate 14. The mating corners 23 are contact surfaces between the flange 21 outer peripheral surface 18 and inner peripheral surface 20, wherein curing an adhesive in the region of the corners quickly will help to hold the window 12 in place while the remaining adhesive can cure at a much slower rate. This is described in greater detail below.

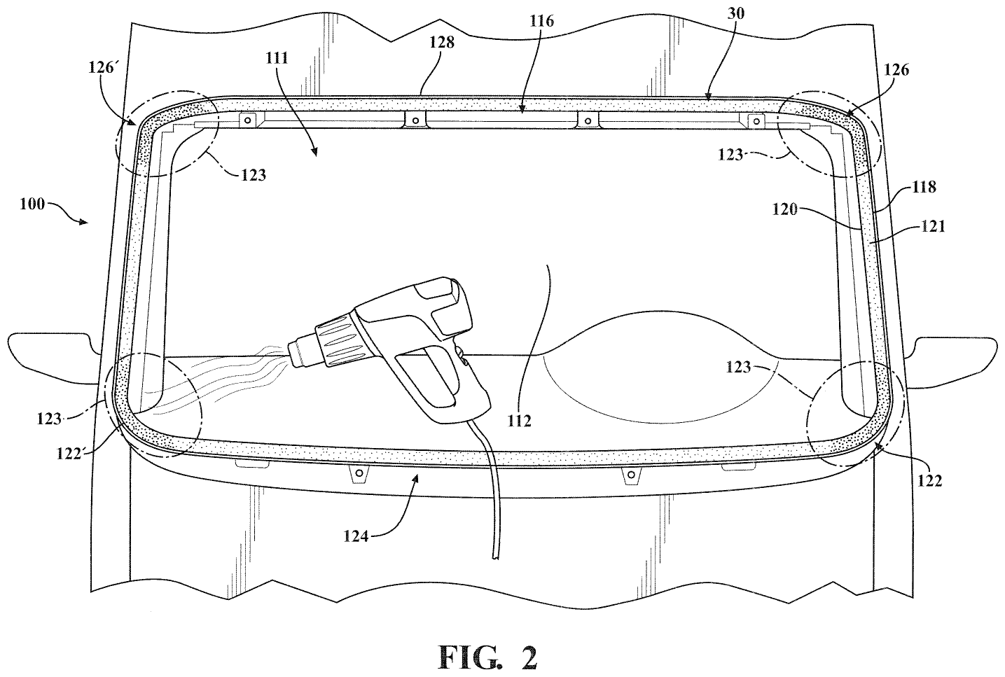

In FIG. 1 the window 12 is a rear window for a vehicle lift gate 14. It is within the scope of this invention for the window to be some other type of automotive window such as a windshield or side window. FIG. 2 shows a front windshield 100 having a frame 116 defining an opening 111 that is covered by a window 112. The frame 116 of the windshield 100 also has with an outer peripheral surface 118 and inner peripheral surface 120 with a flange 121 there between that extends generally around the opening 111 of the windshield. The flange 121 has two or more mating corners 123 where there are two top corners 126, 126′ and two bottom corners 122, 122′. The bottom corners 122, 122′ are located adjacent a lower portion 124 of the windshield 100, while the top corners 126, 126′ are located adjacent or near an upper frame 128 of the windshield 100. The mating corners 123 are contact surfaces on the flange 121 between the outer peripheral surface 118 and inner peripheral surface 120, wherein curing an adhesive in the region of the corners quickly will help to hold the window 112 in place while the remaining adhesive can cure at a much slower rate.

Next the process includes applying a bead of curable adhesive 30 at least partially around the flange 21, 121 or the outer peripheral surface of the window 12, 112 such that the bead of curable adhesive 30 is positioned between the inner peripheral surface 16, 116 in the outer peripheral surface 20, 120. The bead of curable adhesive 30 is a single component adhesive or it may be part of a two component adhesive depending on the needs of a particular application. The step of applying adhesive also includes two or more preselectable areas located in the region of two or more the mating corners 122, 122′, 126, 126′ receiving a boosting agent added to the bead of curable adhesive 30. The boosting agent speeds up the curing process at the preselected areas in order to cause the window 12, 112 to more quickly bond to the lift gate 14 or windshield 100 at the locations of the at least two of the four corners. This allows the window 12, 112 to stay in place and not slide off well the remainder of the bead of curable adhesive 30 cures over several days. Applying the booster agent to a preselected area also cuts down on cost since only a small amount of boosting agent is being used and a single component adhesive can still be used, which also saves costs over a two component system.

Once the boosting agent has been applied at the preselected areas a localized heat source, such as an infrared heat lamp or heat gun is applied to the bead of adhesive where the booster has been applied. The heat source a localized temperature of at least 60° C., with a preferred range of 60° C. to 80° C. in order to speed up the curing process at the two or more preselected areas.

In one embodiment of the invention, the type of adhesive used as an isocyanate urethane adhesive with a polyester polyol booster. Examples of specific adhesives include, but are not limited to Yokohama VVS202FK with B1M booster and or WS242FK with AN-1 booster manufactured by Yokohama America Inc., 103 Kuhlman Blvd. Versailles, Ky. 40383. Another exemplary adhesive and booster is Sikaflex®-271+2% Sika® Booster 20W manufactured by Sika Corporation, 201 Polito Ave., Lyndhurst, N.J. 07071.

However it is within the scope of this invention for the booster to be any compound containing a reactive hydrogen. Specific boosters includes compounds containing alcohols, amines or metal based boosters including metals such as tin bismuth and zinc. Specific example of metal based boosters include but are not limited to dibutyl tin dilaurate, mecaptides including a water-soluble, organotin catalyst, water-soluble bisbuth based catalysts and a zine based catalysts.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A process for adhering a window to a frame comprising the steps of:
providing a frame for a window having an inner peripheral surface defining an opening in the frame and an outer peripheral surface of the frame, wherein the inner peripheral surface and the outer peripheral surface have two or more mating corners;
applying a bead of curable adhesive at least partially around the opening in the frame on a flange between the inner peripheral surface and the outer peripheral surface, wherein applying the bead of curable adhesive further includes applying to at least two or more preselected areas located at the two or more mating corners and a boosting agent that is added to the curable adhesive for securely holding the window in place upon assembly of the window into the frame;
providing a window having an edge;
placing the window on the frame such that a portion of the inside surface of the window extends over the flange and the edge aligns with the outer peripheral surface of the frame wherein the bead of curable adhesive and the boosting agent is positioned between an inside surface of the window and the flange of the frame.

2. The process of claim 1 further comprising assembling the window into the frame and the window is held in the frame at the pre-selected areas during the curing of the curable adhesive.

3. The process of claim 2 wherein the bead of adhesive is applied over the entire flange of the frame or the portion of the inside surface of the window that overlaps the flange of the frame.

4. The process of claim 3 wherein the boosting agent is applied to at least two areas around the flange of the frame or the portion of the inside surface of the window that overlaps the flange of the frame.

5. The process of claim 4 wherein the window is a windshield.

6. The process of claim 4 where the adhesive is selected from a water curable adhesive, a two component adhesive or combinations thereof.

7. The process of claim 2 further comprising applying an infrared heat source locally to the two or more mating corners to accelerate the curing process.

8. The process of claim 1 wherein the two or more corners include two top corners located at the top of the peripheral surface of the frame and two bottom corners located at the bottom of the peripheral surface of the frame, wherein the two or more preselected areas are the two bottom corners.

9. The process of claim 1 consisting essentially of the curable adhesive is an isocyanate urethane adhesive and the boosting agent is a polyester polyol booster.

10. The process of claim 1 wherein the boosting agent consists essentially of one selected from the group comprising polyester polyol booster, dibutyl tin dilaurate, mecaptides including a water-soluble, organotin catalyst, water-soluble bisbuth based catalysts and a zine based catalysts.

11. A process for adhering a window to a frame comprising the steps of:
providing a frame for a window having an inner peripheral surface defining an opening in the frame and an outer peripheral surface of the frame, wherein the inner peripheral surface and the outer peripheral surface have two or more mating corners;
providing a curable adhesive and a boosting agent;
mixing a curable adhesive with a boosting agent;
applying a bead of the curable adhesive and boosting agent at least partially around the opening in the frame on a flange between the inner peripheral surface and the outer peripheral surface, wherein applying the bead of curable adhesive and boosting agent further includes applying to at least two or more preselected areas located at the two or more mating corners for securely holding the window in place upon assembly of the window into the frame;
providing a window having an edge;
placing the window on the frame such that a portion of the inside surface of the window extends over the flange and the edge aligns with the outer peripheral surface of the frame wherein the bead of curable adhesive and the boosting agent is positioned between an inside surface of the window and the flange of the frame.

12. The process of claim 11 further comprising assembling the window into the frame and the window is held in the frame at the pre-selected areas during the curing of the curable adhesive.

13. The process of claim 12 wherein the bead of adhesive is applied over the entire flange of the frame or the portion of the inside surface of the window that overlaps the flange of the frame.

14. The process of claim 13 wherein the boosting agent is applied to at least two areas around the flange of the frame or the portion of the inside surface of the window that overlaps the flange of the frame.

15. The process of claim 11 wherein the window is a windshield.

16. The process of claim 111 where the adhesive is selected from a water curable adhesive, a two component adhesive or combinations thereof.

17. The process of claim 11 further comprising applying an infrared heat source locally to the two or more mating corners to accelerate the curing process.

18. The process of claim 11 wherein the two or more corners include two top corners located at the top of the peripheral surface of the frame and two bottom corners located at the bottom of the peripheral surface of the frame, wherein the two or more preselected areas are the two bottom corners.

19. The process of claim 11 consisting essentially of the curable adhesive is an isocyanate urethane adhesive and the boosting agent is a polyester polyol booster.

20. The process of claim 11 wherein the boosting agent consists essentially of one selected from the group comprising polyester polyol booster, dibutyl tin dilaurate, mecaptides including a water-soluble, organotin catalyst, water-soluble bisbuth based catalysts and a zine based catalysts.
